(19) United States
(12) Patent Application Publication
(10) Pub. No.: US 2022/0134214 A1
(43) Pub. Date: May 5, 2022

(54) GAME-COURT-SURFACE PROJECTOR

(71) Applicant: Shalinder Gupta, Metairie, LA (US)

(72) Inventor: Shalinder Gupta, Metairie, LA (US)

(21) Appl. No.: 17/086,246

(22) Filed: Oct. 30, 2020

(51) Int. Cl. A63C 19/06; H04N 9/31

(52) U.S. Cl. CPC A63C 19/065; H04N 9/3141

(57) ABSTRACT

A game-court-surface projector system and method providing projection of a variety of projected images upon a game court or half court, showing proper boundaries and lines for various games and levels of play, allowing multiple uses for one game court or half court, allowing the development of new games or variants, and allowing improved training and practice by using accurate boundaries and lines for different games and levels of play, and using other projected images.

### BACKGROUND OF THE INVENTION

This invention provides a game-court-surface projector system and method providing projection of a variety of projected images including boundaries and lines upon a game court or half court.

Basketball and similar games are played officially on large courts with exact dimensions which vary depending upon the league or level of play. At private residences and at many schools and playgrounds, there is not sufficient clear space to maintain a full-sized court. Even where space the equivalent of a half court is used, such space is often required to be used for other sports or for other purposes. If boundaries and lines for a specific type and variant of a specific sport are painted onto the court or half court, those lines are not correct for use with other variants and other sports.

For example, in basketball, the overall length of the court, and therefore the placement of the half-court line, is shorter for high school games than for professional and college games. The placement of free-throw and three-point lines is different among the levels of basketball. College basketball provides different lines for men's and for women's games.

If a player is training or practicing for eventual play upon a specific court, any improper placement of boundaries and lines on the practice court can interfere with the effectiveness of the training.

When a team sport is played by a single player or small number of players, it can be advantageous to modify boundaries and lines to adapt to the smaller number of players.

What is needed is a system and method of placing appropriate boundaries and lines upon a court for one use, with the ability to easily change them for another use.

US Patent Application Publication No. 2016/0246039 for an “Interactive Projection System,” published on Aug. 25, 2016 by applicant The Regents of the University of Michigan, discloses an interactive projection system for outputting illuminated indicia upon a projection surface. A detection system is operable to detect both stationary and movable features. A control system is operable to determine the position of the stationary and movable features. A reflective device reflects light from a light source (natural and/or artificial) upon the projection surface as the illuminated indicia. A drive system moves the reflective device, thereby moving the illuminated indicia across the projection surface in response to control system thereby simulating the stationary feature on the projection surface as a physical boundary to the illuminated indicia and simulating the movable feature contacting the illuminated indicia.

U.S. Pat. No. 8,690,715 for a “Light Source Projecting Lines Defining Activity Area,” issued on Apr. 8, 2014 to inventor Steven D. Vogt, provides for a lighting system, for use in combination with a basketball backboard device mounted on a pole, the system comprising a plurality of lighting devices positioned adjacent the basketball backboard device. The lighting devices comprise a housing, a connector, a first light source, a lens and a light filter, and a secondary light source. The lens focuses lines defined by the light filter. The first light source is positioned to project the lines on to an activity surface to define a foul lane for a basketball court. The connector connects the housing to the pole supporting the basketball backboard device. The secondary light source is positioned to simultaneously illuminate a backboard of the basketball backboard device while the first light source projects the lines through the lens and the light filter. The lines from the first light source combine together on the activity surface to define an area for a basketball game.

Korean Patent No. 10-1978325 for an “Apparatus for Displaying Sports Field Line and Net Using Laser,” issued on May 14, 2019 to applicants DONGSEO TECHNOLOGY HEADQUARTERS et al., provides for a stadium line and net display device using a laser. The device marks a boundary in forming a stadium, thereby eliminating discomfort caused by inhalation of powder, and removing the powder during a game. It is possible to eliminate disputes that may arise due to ambiguity, and because there is no need to install the net to raise or lower the position according to the type of game, the game can be performed quickly and easily. It can be easily modified so that it can be played at any time, so it can be used in a variety of places due to its high adaptability to the space, and its portability and installation is easy. It can be easily removed after the game is over, so that it can be used again as the original space. Through the user's mobile terminal, various sizes of stadiums can be accommodated. By determining the standard and forming a line of the stadium corresponding to the boundary of the stadium using a laser, the shape of the stadium is formed, and the net is formed through the laser transceiver included in the net pillar, and whether the line of the stadium and the net are in contact. By adding a warning light so that users of various age groups can play their favorite games, a new laser can be provided.

Korean Patent No. 10-1199421 for an “Apparatus for Displaying Sports Field Line,” issued on Nov. 9, 2012 to applicant Sungkyunkwan University, provides for a stadium line display device for displaying a stadium of various types and standards on the floor outdoors or indoors by irradiating a laser beam. The stadium line display device according to the present invention comprises a housing forming an appearance; a beam generator installed inside the housing and irradiating a laser beam to display a stadium of various types and specifications on an outdoor or indoor floor; and, it is formed on one side of the outer surface of the housing comprises a fixing portion detachably coupled to the external structure.

U.S. Pat. No. 10,653,936 for a “Free Kick Distance Projecting Device,” issued on May 19, 2020 to inventor Natalis Ganzer, provides for a display device for displaying a marking in the form of a distance to be kept between game equipment, in particular a football, and a participant on a playing field of a sports facility, and includes a display device for projecting light beams representing the marking onto the playing field. The projected light beams display the distance to be kept, and can be projected at least in sections in the shape of a circle, for example at a distance of 9.15 m, around the game equipment on the playing field. The display device is jointly movable with a transport device that is movable above the sports facility.

U.S. Pat. No. 8,979,273 for a “Line Display System Using Projector,” issued on Mar. 17, 2015 to assignee Seiko Epson Corporation, provides for a line display system capable of changing a line easily when the sporting event is changed, the line display system including plural projectors, each of which is installed to project a line image on a floor surface or a ground surface.

U.S. Pat. No. 5,342,041 for a “Guiding System for Athletes,” issued on Aug. 30, 1994 to inventors Aaron Agulnek et al., provides for an apparatus for assisting players during practices or in games, such as basketball, in which a ball or other object is directed toward a desired location. A video camera detects the ball and provides a signal indicating the location of the ball. A processor uses the location to determine an optimal location to direct the ball, and provides a signal to an illumination system. The illumination system provides a visual indication of where the player should direct the ball. The apparatus should be able to accommodate a game in which a ball may move quickly.

U.S. Pat. No. 5,684,453 for a “Basketball Training Apparatus,” issued on Nov. 4, 1997 to inventor Scott A. Welch, provides for an electronic basketball training apparatus that instructs a player to move to a sequence of zones and allows the player a limited amount of time to make a basket in each zone. The apparatus computes results and statistics which can be printed out or viewed from a computer screen. The invention can have the computer automatically communicate or allow a coach to communicate the next zone to the player. The invention uses a switch sensor in the basketball net to sense when a basket is made, laser beam sensors on the floor to locate the position of the player, a controller, memory, software, a visual display terminal, a printer, and a speaker to perform the training routine.

### SUMMARY OF THE INVENTION

This invention provides a game-court-surface projector providing projection of a variety of projected images upon a game court or half court, showing proper boundaries and lines for various games and levels of play. The game-court-surface projector allows multiple uses for one game court or half court, allows the development of new games or variants, and allows improved training and practice by using accurate boundaries and lines for different games and levels of play, and using other projected images.

A projector unit projects a projected image using light from a light supply unit, controlled by a control link and control unit. The game-court-surface projector provides projection of boundaries and lines for a variety of games, and projection of information display images virtual object images, location marker images, and virtual layout images.

### BRIEF DESCRIPTION OF THE DRAWINGS

Reference will now be made to the drawings, wherein like parts are designated by like numerals, and wherein:

FIG. 1 is a schematic view of the game-court-surface projector of the invention in use;

FIG. 2 is a schematic view of the game-court-surface projector of the invention in use for a professional basketball court;

FIG. 3 is a schematic view of the game-court-surface projector of the invention in use for a college basketball court;

FIG. 4 is a schematic view of the game-court-surface projector of the invention in use for a high school basketball court;

FIG. 5 is a schematic view of the game-court-surface projector of the invention in use with an information display image;

FIG. 6 is a schematic view of the game-court-surface projector of the invention in use with virtual object images;

FIG. 7 is a schematic view of the game-court-surface projector of the invention in use with a location marker image; and

FIG. 8 is a schematic view of the game-court-surface projector of the invention in use with a virtual layout image.

### DETAILED DESCRIPTION OF THE INVENTION

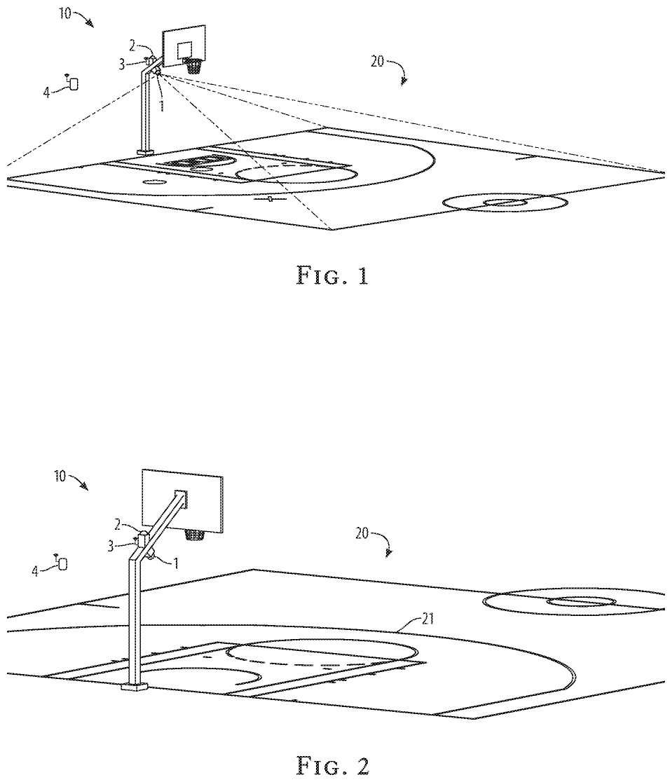

Referring to FIG. 1 the game-court-surface projector 10 of the invention is shown in use projecting a projected image 20 on the surface of a game court such as a basketball court. The image is projected from a projector unit 1 suspended above the game court at an optimal place that is not obtrusive to the use of the court, such as the location on a basketball backboard support as shown. Light for the projected image is supplied by the light supply unit 2. In an all-light embodiment, the light supply unit 2 can gather incident ambient light such as sunlight and focus, concentrate, and amplify that light sufficiently to project an image which is visible in that ambient light, and can also supply light from an incorporated artificial light source, such as LED lighting known in the art. Such an all-light embodiment would allow daytime use as well as low-lighting or nighttime use. An alternative embodiment provides a light supply unit 2 sufficiently powerful to be used in daylight or high ambient light conditions. Another alternative embodiment provides a light supply unit 2 sufficient for use in low ambient light conditions.

The game-court-surface projector 10 also provides a control link 3 and a control unit 4 for controlling the projected image 20. In a wireless embodiment, as shown, the control link 3 provides wireless communication as known in the art, and the control unit 4 is a wireless hand-held remote-control unit. The control unit 4 can be a purpose-built unit or the control unit 4 function can be implemented on a smartphone, tablet, laptop computer, or other device having wireless communications capabilities.

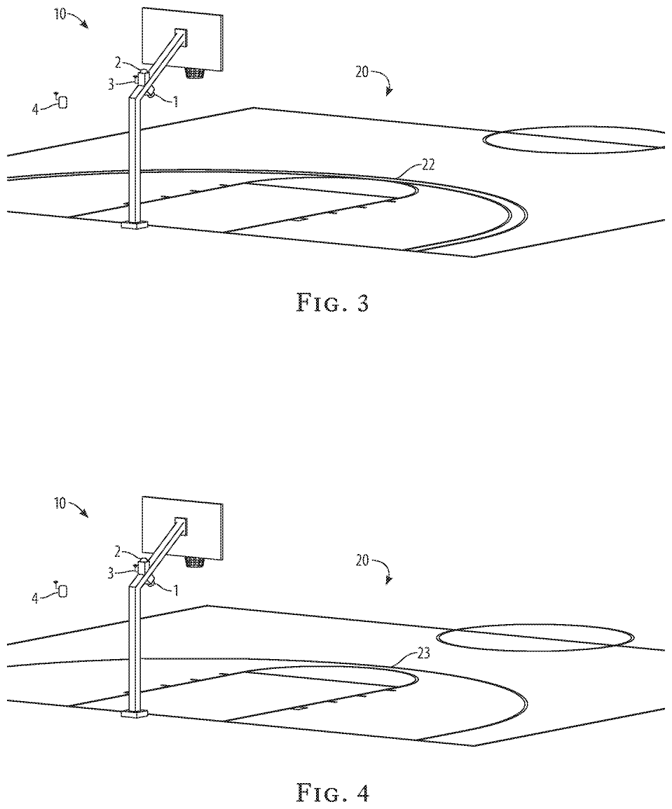

Referring to FIG. 2, FIG. 3, and FIG. 4, the game-court-surface projector 10 is shown in use projecting a professional basketball court image 21, a college basketball court image 22, and a high school basketball court image 23, respectively. The different levels of basketball use different court configurations with different distances and different placement of lines. The game-court-surface projector 10 projects the proper boundaries and lines for a given level of play, and can then be changed to project other boundaries and lines. Use on a half court is shown. Use on a full court would be best implemented with two projectors. It is anticipated that the game-court-surface projector 10 will be useful in half-court setups such as a residential driveway, a playground, training and practice facilities, and other circumstances where space is limited or where space must also be used for other games or purposes. The game-court-surface projector 10 facilitates the use of a game court or half court for a variety of games or other purposes because no lines or markers need to be painted permanently on the court, but can be projected as needed and quickly changed as needed. With the game-court-surface projector 10 a player or a team of players would be able to train or play on a court or half-court having the appropriate boundaries and lines for an accurate specific court configuration, and then the court could be put into a different configuration for different players or purposes.

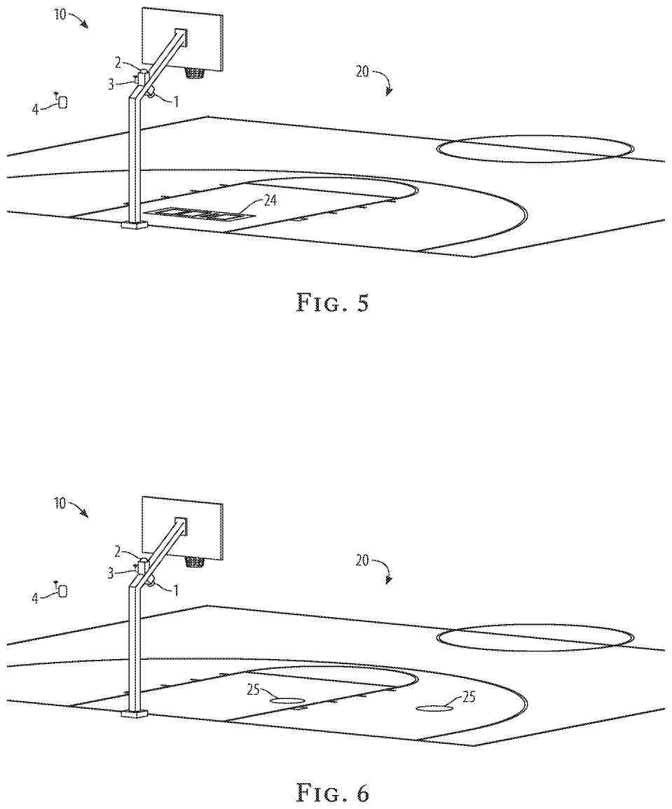

Referring to FIG. 5, the game-court-surface projector 10 can project an information display image 24 onto the court surface. As shown, the information display image 24 can be an indicator of time, such as time available to make a free throw or time elapsed or remaining. The information display image 24 can also be a score or the letters comprising “horse”. By displaying such information on the court itself both players and spectators can more easily see the information instead of having to look away from the court toward a scoreboard, or on a court not having a scoreboard, such as a driveway, playground, or practice court. The information displayed can be controlled through the control link 3 and control unit 4.

Referring to FIG. 6, the game-court-surface projector 10 can project one or more virtual object images 25 onto the court surface. The virtual object image 25 can represent an opposing player or an obstacle, and can be moved around on the court controlled by the control link 3 and control unit 4. Virtual object images 25 can be used to simulate play for training purposes or to make play more challenging or interesting for a single player or small number of players.

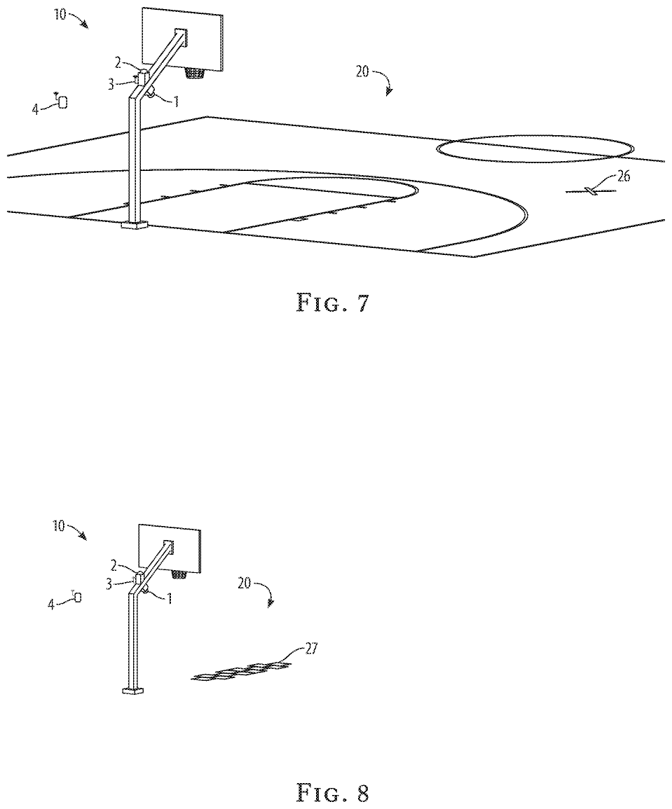

Referring to FIG. 7, the game-court-surface projector 10 can project one or more location marker images 26 onto the court surface. A location marker image 26 might be used to indicate, for example, a spot from which a player is required to make a shot. Location marker images 26 can be placed under control by the control link 3 and control unit 4, and can be used to, for example, provide a comprehensive drill or practice of different types of shots, or to invent games or variations of games.

Referring to FIG. 8, the game-court-surface projector 10 can project a virtual layout image 27 onto the court surface. The virtual layout image 27 can represent a game of hopscotch, as shown, or can provide boundaries and lines for other games, including custom-made games and games having changing boundaries and lines, under the control of the control link 3 and control unit 4. For example, games could be devised in which the boundaries and lines change according to the number of players participating or change with the passage of time.

Many other changes and modifications can be made in the system and method of the present invention without departing from the spirit thereof. I therefore pray that my rights to the present invention be limited only by the scope of the appended claims.

I claim:

1. A game-court-surface projector system comprising:
(i) a projector unit adapted to project a projected image upon a game court surface;
(ii) a light supply unit adapted to supply light to said projector unit;
(iii) a control link adapted to provide communications with said projector unit; and
(iv) a control unit adapted to provide control through said control link.

2. The game-court-surface projector system of claim 1, where said light supply unit further comprises adaptation to focus and concentrate incident ambient light.

3. The game-court-surface projector system of claim 1, where said light supply unit further comprises an artificial light source.

4. The game-court-surface projector system of claim 1, where said projected image further comprises a basketball court image.

5. The game-court-surface projector system of claim 1, where said projected image further comprises an information display image.

6. The game-court-surface projector system of claim 1, where said projected image further comprises a virtual object image.

7. The game-court-surface projector system of claim 1, where said projected image further comprises a location marker image.

8. The game-court-surface projector system of claim 1, where said projected image further comprises a virtual layout image.

9. The game-court-surface projector system of claim 5, where said information display image further comprises an indication of time.

10. The game-court-surface projector system of claim 5, where said information display image further comprises score information.

11. The game-court-surface projector system of claim 6, where said virtual object image further comprises representation of an opposing player.

12. The game-court-surface projector system of claim 6, where said virtual object image further comprises representation of an obstacle.

13. The game-court-surface projector system of claim 7, where said location marker image further comprises an indication of a location from which to make a shot.

14. The game-court-surface projector system of claim 8, where said virtual layout image further comprises boundaries and lines for a game.

15. The game-court-surface projector system of claim 1, where said projected image further comprises a changing image.

16. The game-court-surface projector system of claim 1, where said projected image further comprises changeable images corresponding to a number of participating players.

17. The game-court-surface projector system of claim 1, where said projected image further comprises changeable images corresponding to passage of time.

18. A game-court-surface projection method comprising:
(i) providing a game-court-surface projector comprising:
(a) a projector unit adapted to project a projected image upon a game court surface;
(b) a light supply unit adapted to supply light to said projector unit;
(c) a control link adapted to provide communications with said projector unit; and
(d) a control unit adapted to provide control through said control link;
(ii) projecting said projected image upon the game court surface under control of said control link and said control unit; and
(iii) changing said projected image under control of said control link and said control unit.

19. The game-court-surface projection method of claim 18, further comprising using said game-court-surface projector to devise new activities and games.

20. The game-court-surface projection method of claim 18, further comprising using said game-court-surface projector for player training and practice.
